(19) United States
(12) Patent Application Publication
(10) Pub. No.: US 2009/0255027 A1
(43) Pub. Date: Oct. 15, 2009

(54) RAIN LEGGINGS

(76) Inventor: Peter J. Laitmon, New York, NY (US)

Correspondence Address: MEREDITH & KEYHANI, PLLC, 330 MADISON AVE., 6TH FLOOR, NEW YORK, NY, 10017, US

(21) Appl. No.: 12/246,227

(22) Filed: Oct. 6, 2008

Related U.S. Application Data
(63) Continuation of application No. 10/811,048, filed on Mar. 27, 2004, now abandoned.

(51) Int. Cl. A41D 13/00; B26D 3/08; A41F 3/02

(52) U.S. Cl. 2/22; 83/880; 2/338

(57) ABSTRACT

A roll of protective legging structures comprising a multitude of one-piece disposable protective rain leggings wherein each of one piece disposable protective plastic rain leggings are serially adjoined and wound into a roll. The protective rain legging comprising: a waterproof leg encircling portion having a uniform width from the top opening to the knee and gradually increases from the knee to the bottom opening; the top opening being higher on the outer side of leg encircling portion, and sloping downward towards the lower inner side; and an attachment means fixedly attached to the outer side of the top opening, for attaching the leg encircling portion to the waist portion of a garment worn by the wearer.

This application claims priority and is a continuing application to co-pending patent application Ser. No. 10/811,048 entitled “RAIN LEGGINGS” filed Mar. 27, 2004.

### BACKGROUND OF THE INVENTION

The present invention generally relates to protective outerwear, particularly leggings used to protect the wearer's legs, clothing and shoes in rainy or wet conditions. The present invention may also be disposable. Numerous protective chaps are known within the art. By way of example U.S. Pat. No. 4,984,303 issued to Ross discloses rain chaps, which protect the front side of the wearer from rain or frontal contact with wet objects. The rain chaps consist of two leg portions affixed to a belt. Straps attached to the leg portions keep the leg portions snugly in position to the front of the wearers legs. This invention does nothing to protect the back side of the wearers legs from rain or wet objects, and does nothing to protect the wearers shoes from water as the leg portions extend only to the ankles.

U.S. Pat. No. 4,509,213 issued to Harvey, discloses a pair of leggings adjoined at the waist to protect the lower body of a motorcycle rider including his feet from the rain. The rain cover comprises a pair of pants consisting of leggings and a gaiter like foot covering portion that leaves only the sole of the shoe exposed. The Harvey invention, as a one-piece garment, fully covers the waist of the wearer; this makes quick dressing difficult, and ultimately cumbersome.

U.S. Pat. No. 4,110,845 issued to Chellis. discloses Rain Chaps to protect the lower legs of the wearer from rain. The Chellis invention is composed of lightweight material and incorporates straps to connect the upper edge of the chap to the belt of the wearer. The chaps can be snapped or releasable along a longitudinal inside seam, to facilitate easy putting on and removal. Although the Chellis invention protects the lower leg, it does nothing to protect the upper leg from rain or wet objects.

U.S. Pat. No. 5,987,778 issued to Stoner discloses protective footwear and lower leg covering. The boot cover is constructed of heavy durable material, which has an open sole and connects to a reinforced lower leg covering. Both the boot and leg covering are open in the back so that the article can be directly fastened to the leg and foot, rather than pulled on. This protective boot however is made to protect the front of the foot and shin from debris, but not the back of the leg and foot, rather complicated to put on and cumbersome.

Although rain chaps and protective foot coverings exist within the art, what are needed are protective chaps that are easily donned, and protect the upper and lower leg as well as the shoe in rainy or wet conditions.

### SUMMARY OF THE INVENTION

The present invention provides a protective legging, which can be worn on a leg as a measure of protection from the rain or other wet conditions.

According to the first embodiment of the present invention, a protective rain legging is disclosed, comprising: a waterproof leg encircling portion with an inner side, an outer side, a top opening and a bottom opening. The top opening is higher on the outer side of the leg-encircling portion, and slopes downward towards the lower inner side of the top portion of the legging. An attachment means is fixedly attached to the outer side of the top opening, for attaching the leg-encircling portion to the waist portion of a garment worn by the wearer.

According to another embodiment of the present invention, a protective rain legging is disclosed comprising: a waterproof leg encircling portion with an inner side, an outer side, a top opening and a bottom opening, an attachment means, and an insulating layer. The top opening is higher on the outer side of the leg encircling portion, and slopes downward towards the lower inner side of the legging. An attachment means is comprised of a first piece of fabric fixedly attached to the outer portion of the top opening of the legging. The first piece of fabric is long enough to allow the second end of the first piece of fabric to be attached to the garment around the waist of the wearer using a Velcro strip as a securing means. The insulating layer is fixed into the inside of the leg-encircling portion.

According to a third embodiment of the present invention, a one-piece disposable protective plastic rain legging is disclosed, comprising: a plastic leg encircling portion with an inner side, an outer side, a top opening, a bottom opening and attachment means. The top opening is higher on the outer side of the leg-encircling portion, and slopes downward towards the lower inner side of the leg-encircling portion. The attachment means extends from the outer side of the top opening.

According to yet another embodiment of the present invention, a roll of protective legging structures is disclosed, comprising; a multitude of one-piece disposable protective rain leggings wherein each of the one piece disposable protective plastic rain leggings is serially adjoined and wound into a roll.

According to still yet another aspect of the present invention, a method of manufacturing a multitude of legging structures serially adjoined in package roll form having the following steps; providing an indeterminate length of tubular plastic; stamping a perforation at points in the length of tubular plastic forming serially connected legging structures; rolling the serially connected legging structures up.

This summary is not to be taken in a limiting sense, but is made merely for the purpose of illustrating the general principles of the invention, since the scope of the invention is best defined by the appended claims.

### BRIEF DESCRIPTION OF THE DRAWINGS

FIG. 1A is a front view of a protective rain legging according to an embodiment of the present invention;

FIG. 1B is a side view of a protective rain legging according to an embodiment of the present invention;

FIG. 1C is a side view of a protective rain legging according to an embodiment of the present invention;

FIG. 1D is a rear view of protective rain leggings according to an embodiment of the present invention;

FIG. 2A is a side view of a protective rain legging according to an embodiment of the present invention;

FIG. 2B is a front view of a protective rain legging according to an embodiment of the present invention;

FIG. 2C is a front view of a protective rain legging according to an embodiment of the present invention;

FIG. 2D is a front view of a protective rain legging according to an embodiment of the present invention;

FIG. 2E is a front view of a protective rain legging according to an embodiment of the present invention;

FIG. 3A is a front view of a protective rain legging according to an embodiment of the present invention;

FIG. 3B is a side view of a protective rain legging according to an embodiment of the present invention;

FIG. 3C is a front view of a protective rain legging according to an embodiment of the present invention;

FIG. 4A is a perspective view of a roll of protective rain leggings according to an embodiment of the present invention;

FIG. 4B is a perspective view of a roll of protective rain leggings according to an embodiment of the present invention; and

FIG. 5 is a flowchart depicting a method of manufacturing a multitude of legging structures according to an embodiment of the present invention.

### DETAILED DESCRIPTION OF THE DRAWINGS

The following detailed description is of the best currently contemplated modes of carrying out the invention. The description is not to be taken in a limiting sense, but is made merely for the purpose of illustrating the general principles of the invention, since the scope of the invention is best defined by the appended claims.

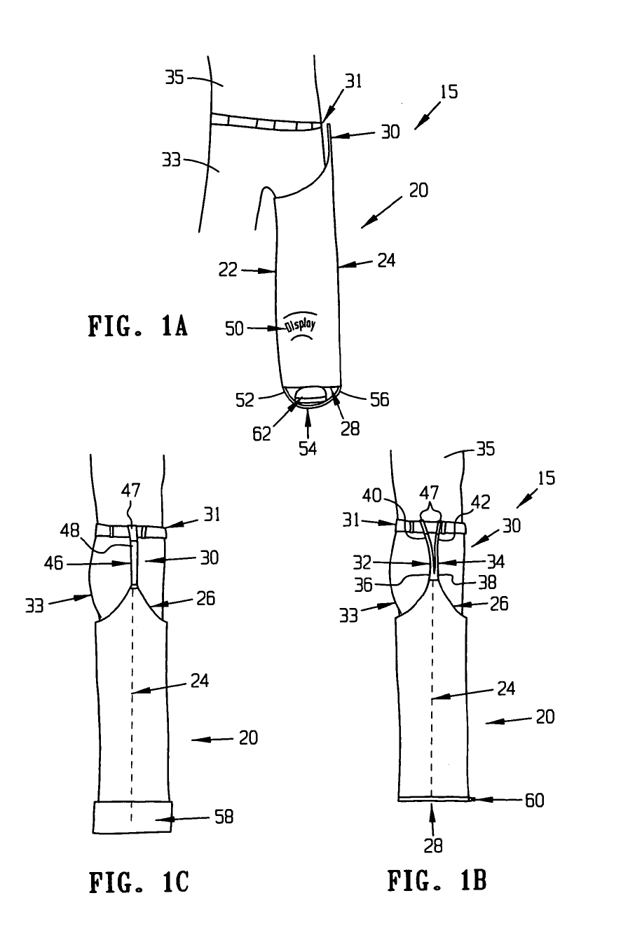

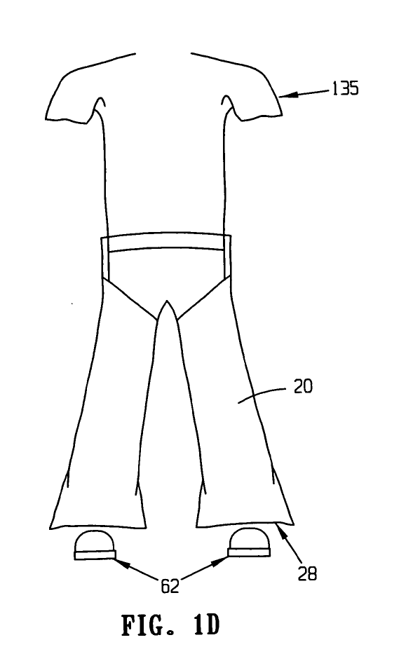

FIG. 1A depicts a protective rain legging 15 comprising: a waterproof leg encircling portion 20 with an inner side 22, an outer side 24, a top opening 26 and a bottom opening 28. The leg-encircling portion may be made out of plastic. The top opening 26 of the leg-encircling portion 20 is higher on the outer side 24 of the leg-encircling portion 20, and slopes downward towards the lower inner side 22 of the leg-encircling portion 20. An attachment means 30 is fixedly attached to the outer side 24 of the top opening 26, which attaches the leg-encircling portion 20 to the waist portion 31 of a garment 33 worn by the wearer 35. The protective rain legging 15 may further comprise a stirrup 54, wherein a first end 52 of the stirrup 54 is attached to the inner side 22 of the leg-encircling portion 20 and a second end 56 of the stirrup 54 is attached to the outer side 24 of the leg-encircling portion 20, providing a stirrup 54 that runs across the underside of the wearers shoe 62. The leg encircling portion 20 may have a promotional display 50 thereon which may be a logo, advertisement, brand name, trademark or emblem. The promotional display may be printed a plastic leg encircling portion. As shown, the top opening 26 may be higher on the outer side 25 of the leg encircling portion, and sloping downward towards the lower inner side 22 at an angle between 30 and 90 degrees to provide water proof protection on the outside of the wearers leg.

As shown in FIG. 1B, the attachment means 30 of the protective rain legging 15 may be comprised of a first piece of fabric 32 and a second piece of fabric 34. The first end 36 of the first piece of fabric 32 and the first end 38 of the second piece of fabric 34 are fixedly attached to the outer side 24 of the top opening 26 of the leg encircling portion 20. The first piece of fabric 32 and the second piece of fabric 34 are long enough to allow the second end 40 of the first piece of fabric 32 and the second end 42 of the second piece of fabric 34 to be joined around the waist portion 31 Of the wearer using a securing means 47. The securing means 47 may be Velcro, buckle, clip, snap, button, or a tie. The bottom opening 28 of the leg-encircling portion 20 may further comprise a tightening means 60 which may be a drawstring or elastic. The term fabric may include any cotton, silk, wool, jute, flax, corduroy, burlap, leather, dimpled leather, dotted Swiss, denim, chiffon, satin, chambray, organdy, plastic, felt and any other fabric that may be used to make clothing items.

As shown in FIG. 1C, the attachment means 30 may be comprised of a single first piece of fabric 46 fixedly attached to the outer portion 24 of the top opening 26 of the leg-encircling portion 20. The first piece of fabric 46 is long enough to allow the second end 48 of the first piece of fabric 46 to be attached to the garment around the waist of the wearer using a securing means 47. The securing means 47 may be hook and loop (Velcro®), buckle, clip, snap, button, or a tie. The leg-encircling portion 20 may also be lined with an insulating material 58.

As shown in FIG. 1D the diameter of the leg-encircling portion 20 may increase approaching the bottom opening 28, providing a bottom opening 28 that substantially covers and protects the shoes 62 of the wearer 35, leaving soles of the shoe 62 exposed. As shown, the top opening may be higher on the outer side of the leg encircling portion, and sloping downward towards said lower inner side at an angle between 30 and 90 degrees to provide water proof protection on the outside of the wearers leg.

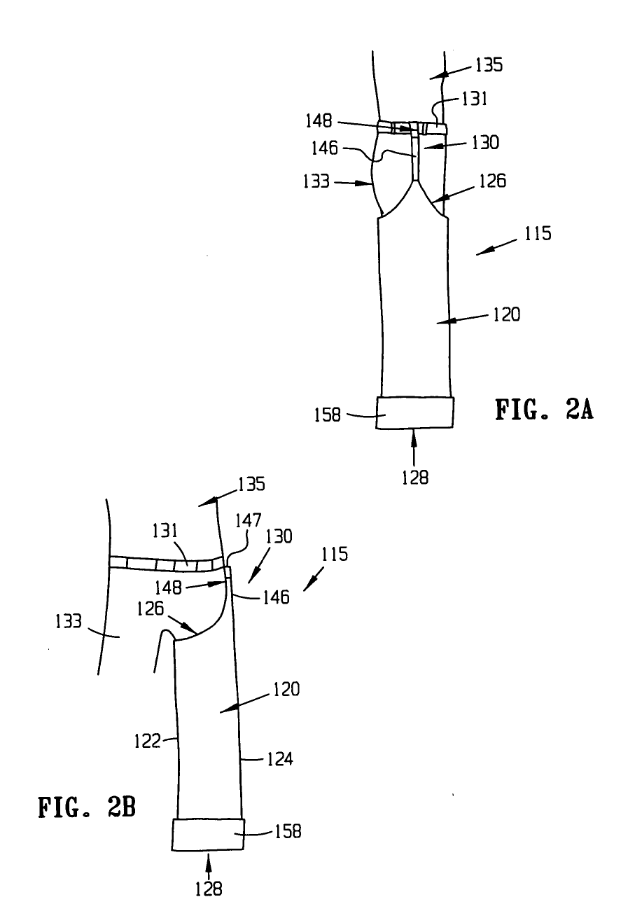

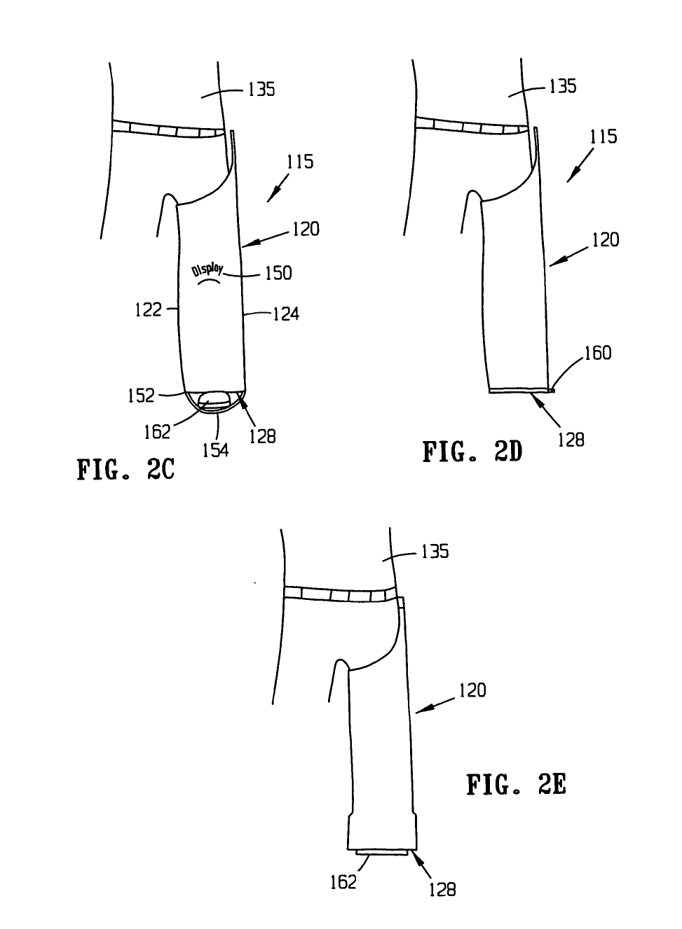

FIGS. 2A and 28 depict a protective rain legging 115 comprising: a waterproof leg encircling portion 120 with an inner side 122, an outer side 124, a top opening 126 and a bottom opening 128. The top opening 126 of the leg-encircling portion 120 is higher on the outer side 124 of the leg-encircling portion 120, and slopes downward towards the lower inner side 122 of the leg-encircling portion 120. An attachment means 130 is fixedly attached to the outer side 124 of the top opening 126, which attaches the leg-encircling portion 120 to the waist portion 131 of a garment 133 worn by the wearer 135. The attachment means 130 is comprised of a single first piece of fabric 146 fixedly attached to the outer side 124 of the top opening 126 of the leg-encircling portion 120. The first piece of fabric 146 is long enough to allow the second end 148 of the first piece of fabric 146 to be attached to waist portion 131 of a garment 133 worn by the wearer 135 using a securing means 147. The securing means 147 may be Velcro, buckle, clip, snap, button, or a tie. The leg-encircling portion 120 may also be lined with an insulating material 158.

As shown in FIG. 2C the bottom opening 128 of the leg-encircling portion 120 may further comprise a tightening means 160, which may be a drawstring or elastic.

As shown in FIG. 20, the protective rain legging 115 may further comprise a stirrup 154, wherein a first end 152 of the stirrup 154 is attached to the inner side 122 of the bottom opening 128 of the leg-encircling portion 120 and a second end 156 of the stirrup 154 is attached to the outer side 124 of the bottom opening 128 of the leg-encircling portion 120, providing a stirrup 154 that runs across the underside of the wearers shoe 162. The leg-encircling portion 120 may have a promotional display 150 thereon which may be a logo, advertisement, brand name, trademark and emblem.

As shown in FIG. 2E the diameter of the leg-encircling portion 120 may increase approaching the bottom opening 128, providing a bottom opening 128 that Substantially covers and protects the shoes 162 of the wearer 135, leaving sales of the shoe 162 exposed.

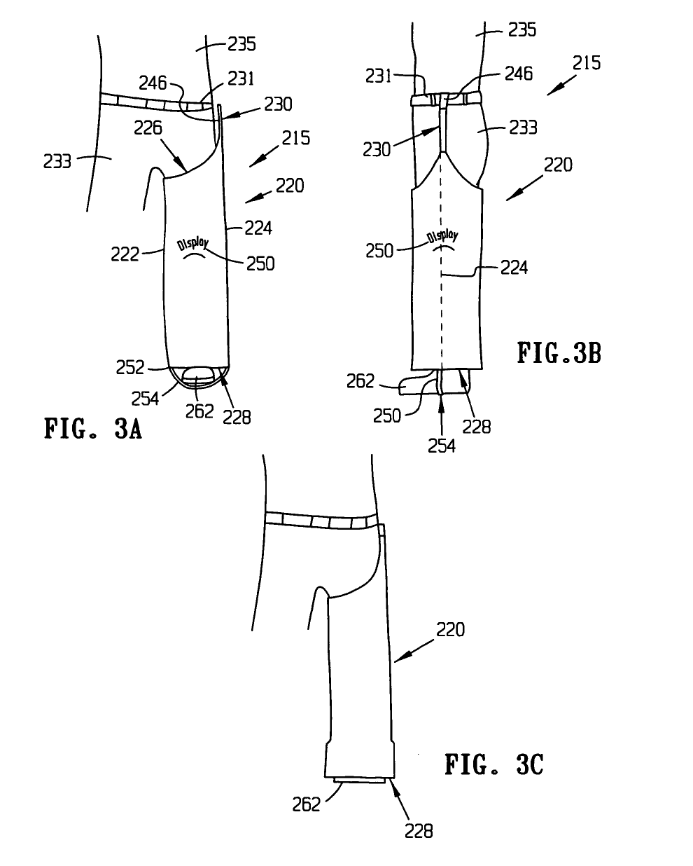

FIGS. 3A and 38 depict a one-piece disposable protective rain legging 215 comprising: a plastic leg encircling portion 220 with an inner side 222, an outer side 224, a top opening 226 and a bottom opening 228. The top opening 226 of the leg-encircling portion 220 is higher on the outer side 224 of the leg-encircling portion 220, and slopes downward towards the lower inner side 222 of the leg-encircling portion 220. An attachment means 230 extending from the outer side 224 of the top opening 226, attaches the leg-encircling portion 220 to the waist portion 231 of a garment 233 worn by the wearer 235. The attachment means 230 may be comprised of a single first piece of plastic 246 extending from the outer portion 24 of the top opening 26 of the leg encircling portion 20. The first piece of plastic 246 is long enough to allow the second end 248 of the first piece of fabric 246 to be attached to the waist portion 231 of a garment 233 worn by the wearer 235. The protective rain legging 215 may further comprise a stirrup 254, wherein a first end 252 of the stirrup 254 is attached to the inner side 222 of the leg-encircling portion 220 and a second end 256 of the stirrup 254 is attached to the outer side 224 of the leg encircling portion 220, providing a stirrup 254 that runs across the underside of the wearers shoe 262. The leg-encircling portion 220 may have a promotional display 250 thereon which may be a logo, advertisement, brand name, trademark and emblem.

As shown in FIG. 3C, the diameter of the leg-encircling portion 220 increases approaching the bottom opening 228, providing a bottom opening 228 that substantially covers the shoes 262 of the wearer, leaving the soles of the shoes exposed.

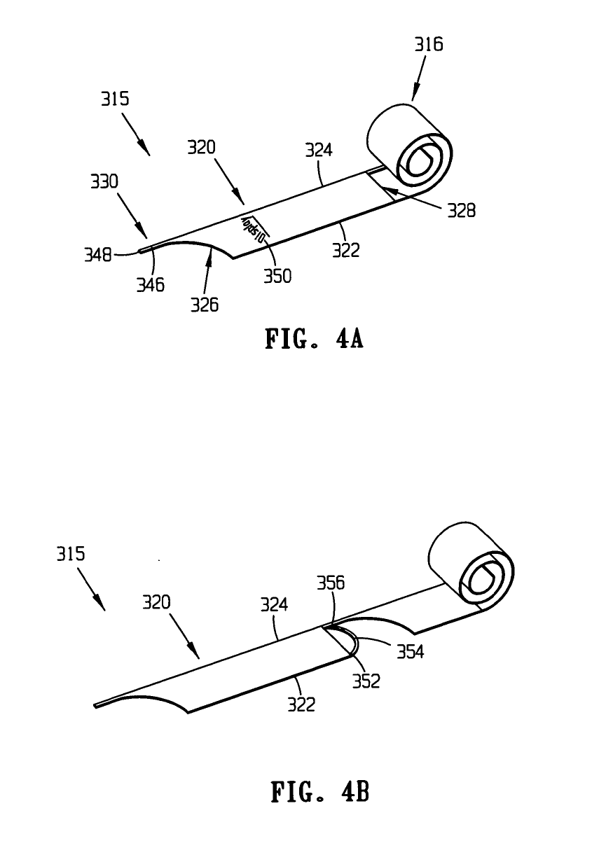

FIG. 4A depicts a roll of protective legging structures 310 comprising; a multitude of one-piece disposable protective plastic rain leggings 315 wherein each of the one-piece disposable protective plastic rain leggings 315 serially adjoined and wound into a roll 316. The one-piece disposable protective plastic rain legging 315 is comprised of; a leg encircling portion 320 with an inner side 322, an outer side 324, a top opening 326, a bottom opening 328 and attachment means, wherein the top opening 326 is higher on the outer side 324 of the leg-encircling portion 320, and sloping downward towards the lower inner side 322, and the attachment means 330 extending from the outer side 324 of the top opening 326. The attachment means 330 may be comprised of a single first piece of plastic 346 extending from the outer portion 324 of the top opening 326 of the leg-encircling portion 320. The first piece of plastic 346 is long enough to allow the second end 348 of the first piece of plastic 346 to be attached to the waist portion of a garment worn by a wearer. The one-piece disposable protective plastic rain leggings 315 may also have a promotional display 350 thereon, which may be a logo, advertisement, brand name, trademark and emblem.

As displayed in FIG. 48, the one-piece disposable protective plastic rain leggings 315 may further comprise a stirrup 354, wherein a first end 352 of the stirrup 354 is attached to the inner side 322 of the leg-encircling portion 320 and a second end 356 of the stirrup 354 is attached to the outer side 324 of the leg-encircling portion 320, providing a stirrup 354 that runs across the underside of the wearers shoe.

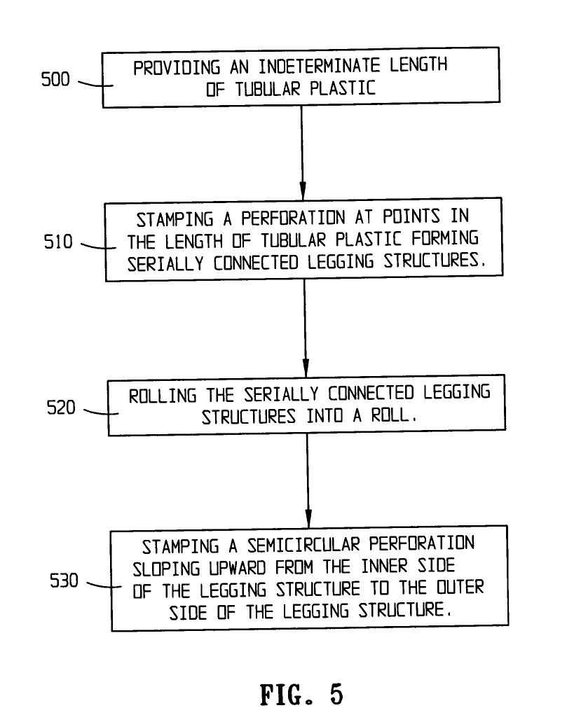

FIG. 5 depicts a method of fabricating a method of manufacturing a multitude of legging structures 315 serially adjoined in package roll form having the following steps: step (500) providing an indeterminate length of tubular plastic. Step (510) is stamping a perforation at points in the length of tubular plastic forming serially connected legging structures. In this way a legging structure may be torn off of the roll to provide a single leg covering. As would typically be the case, two leg coverings can be torn off of the roll to provide a pair of leg coverings. Step (520) is rolling the serially connected legging structures into a roll 310. The method of manufacturing may further comprise the step of stamping a semicircular perforation sloping upward from the inner side of the legging structure to the outer side of the legging structure. The perforation dictates the shape of the leggings and their orientation when connected in package roll form. The leggings may be stamped with the same orientation so the leggings are serially connected where the top of one legging is connected to the bottom of the next legging. The leggings may be also be serially connected while having alternating orientation, wherein leggings are connected top portion to top portion and bottom portion to bottom portion. It should be understood that a multitude of legging shapes, attachment means, and orientations of stamping and interconnection are envisioned.

It should be understood, of course, that the foregoing relates to preferred embodiments of the invention and that modifications may be made without departing from the spirit and scope of the invention as set forth in the following claims.

I claim:

1. A roll of protective legging structures comprising:
a multitude of one-piece disposable protective rain leggings wherein each of said one piece disposable protective plastic rain leggings are serially adjoined and wound into a roll.

2. The roll of protective legging structures as in claim 1, wherein said one-piece disposable protective plastic rain legging is further comprised of a leg encircling portion with an inner side, an outer side, a top opening, a bottom opening and attachment means, wherein said top opening is higher on said outer side of said leg encircling portion, and sloping downward towards said lower inner side, and said attachment means extending from said outer side of said top opening.

3. The apparatus as in claim 1, wherein each of said one-piece disposable protective plastic rain leggings has a promotional display.

4. The apparatus as in claim 2, wherein said attachment means is comprised of a single piece of plastic extending from said outer portion of said top opening of said legging, said single piece of plastic being long enough to allow said piece of plastic to be attached to the garment around the waist of said wearer.

5. The apparatus as in claim 2, further comprising a stirrup having a first end attached to said inner side of said legging, a second end attached to said outer side of said legging, providing a stirrup that runs across the underside of said wearers shoe.

6. A method of manufacturing a multitude of legging structures serially adjoined in package roll form having the following steps:
providing an indeterminate length of tubular plastic; and
stamping a perforation at points in the length of tubular plastic forming serially connected legging structures.

7. A method as in claim 6, wherein said step of stamping further comprises the steps of:
stamping a semicircular perforation sloping upward from said inner side of said legging structure to said outer side of said legging structure.

8. A protective rain legging comprising:
a waterproof leg encircling portion with an inner side, an outer side, a top opening and a bottom opening, wherein said waterproof leg encircling portion is uniform width from said top opening to the knee and gradually increases from said knee to said bottom opening;
said top opening being higher on the outer side of said leg encircling portion, and sloping downward towards said lower inner side at an angle between 30 and 90 degrees to provide water proof protection on the outside of the wearers leg; and
an attachment means fixedly attached to said outer side of said top opening, for attaching said leg encircling portion to the waist portion of a garment worn by the wearer.

9. The apparatus as in claim 8, wherein said attachment:
means is comprised of a first piece of fabric and a second piece of fabric, said first end of said first piece of fabric and said first end of said second piece of fabric are fixedly attached to said outer portion of said top opening of said leg encircling portion, said first piece of fabric and said second piece of fabric being long enough to allow said second end of said first piece of fabric and said end of said second piece of fabric to be joined around the belt of said wearer using a securing means.

10. The apparatus as in claim 9, wherein said securing means are selected from the group consisting of hook and look, Velcro®, buckle, clip, snap, button, tie.

11. The apparatus as in claim 9, wherein said attachment means is comprised of a first piece of fabric fixedly attached to said outer portion of said top opening of said leg encircling portion, said first piece of fabric being long enough to allow said second end of said first piece of fabric to be attached to the garment around the waist of said wearer using a securing means. The apparatus as in claim 9, wherein the diameter of said leg encircling portion increases approaching the bottom opening, providing a bottom opening that substantially covers the shoes of the wearer, leaving the soles of the shoes exposed.

12. The apparatus as in claim 9, wherein a first end of a stirrup is attached to said inner side of said leg encircling portion and a second end of said stirrup is attached to said outer side of said leg encircling portion, providing a stirrup that runs across the underside of said wearers shoe.

13. The apparatus as in claim 9, wherein said leg encircling portion has a promotional display affixed thereto.

14. The apparatus as in claim 9, wherein said leg encircling portion is lined with an insulating material.

15. The apparatus as in claim 9, wherein said bottom opening has a tightening means at said bottom opening of said leg encircling portion.

16. The apparatus as in claim 16, wherein said tightening means is selected from the group drawstring, elastic.

17. One-piece disposable protective plastic rain legging comprising:
a plastic leg encircling portion with an inner side, an outer side, a top opening, a bottom opening and attachment means, wherein said top opening is higher on said outer side of said leg encircling portion, and sloping downward towards said lower inner side, and said attachment means extending from said outer side of said top opening.

18. The apparatus as in claim 17, wherein said attachment means is comprised of a single piece of plastic extending from said outer portion of said top opening of said leg encircling portion, said single piece of plastic being long enough to allow said piece of plastic to be attached to the garment around the waist of said wearer.

19. The apparatus as in claim 17, wherein the diameter of said leg encircling portion increases approaching the bottom opening, providing a bottom opening that substantially covers the shoes of the wearer, leaving the soles of the shoes exposed.

20. The apparatus as in claim 17, further comprising a stirrup having a first end attached to said inner side of said leg encircling portion, a second end attached to said outer side of said leg encircling portion, providing a stirrup that runs across the underside of said wearers shoe.
